(19) United States
(12) Patent Application Publication
(10) Pub. No.: US 2008/0006311 A1
(43) Pub. Date: Jan. 10, 2008

(54) Razor cleaning device

(76) Inventors: James F. Brown, Clarksville, TN (US); Tahonie Brown, Clarksville, TN (US)

Correspondence Address: SUNG I. OH, PROFESSIONAL LAW CORPORATION, 710 QUAIL VALLEY LANE, WEST COVINA, CA, 91791, US

(21) Appl. No.: 11/481,810

(22) Filed: Jul. 6, 2006

(51) Int. Cl. B08B 3/12; B08B 3/00

(52) U.S. Cl. 134/184; 134/198

(57) ABSTRACT

A device into which a razor is placed includes a chamber through which water is circulated to clean the razor. Water jets are included to direct water against the razor. The device further includes a holder for razors after cleaning.

### TECHNICAL FIELD OF THE INVENTION

The present invention relates to the general art of toiletries, and to the particular field of razors.

### BACKGROUND OF THE INVENTION

The use of razors to shave facial or body hair by pulling razor blades across a body surface is well known. The use is typically accomplished with the aid of a lubricating fluid, and with the additional aid of a source of water for cleaning the blade or blades after each pass with the razor has clogged the blade or blades with accumulated lubricating fluid and hair. As it is inconvenient and awkward to turn the water source on and off again with each pass of the razor, the water source is often left on, resulting in a waste of water and, since the water is usually heated, a waste of energy. The aggregation of this waste by millions of individuals on a daily basis is no doubt substantial.

The popularity of parallel blade shaving razors, such as those sold under the trademark “TRAC-II”®, has compounded this problem, as the small spaces between and around the parallel blades provide both an attractive repository for shaving debris and an area that is difficult to clean. Additionally, the parallel blades are encased within the shaving head and not removable from the head for cleaning, unlike a traditional safety razor. As a result, the parallel blade shaving razors can require even more water for cleaning.

One approach to cleaning shaving razors is the use of brushes. Unfortunately, the brush bristles can be cut by the razor blade or blades and can themselves become lodged between and around the razor blades. Conversely, when the bristles are too tough to be cut by the blades they may instead damage the blades. And the cleaning device disclosed in the above referenced patent must still be augmented with watering from a faucet that, as above, is either wasteful or inconvenient.

Another approach to cleaning shaving razors includes a device that is attached to a faucet and that provides a conduit for the water flowing from the faucet to exit through a number of small jets, thereby increasing the water pressure, the jets) directing the water into a cavity that is sized to receive a razor head. While the increased water pressure caused by this device is an improvement over the pressure available in most bathroom sinks, several problems remain.

First, as with all other prior art known to applicant, the user of the device is faced with a choice of turning the device on and off with each pass of the razor or leaving the device running constantly. Turning the water faucet on and off may require several turns of a knob each time the faucet is turned on and several turns of the knob to turn the faucet off again. To perform this requires the use of another hand beside the hand holding the razor, which presents a serious obstacle for people that are either physically handicapped or temporarily handicapped by using their other hand for other purposes, such as holding shaving lubricant. Moreover, each time the faucet is turned off the water drains from the conduit between the faucet valve and the jets, causing an air pocket to form that must be expelled each time the faucet is turned on before water exits the jets. And the jets will not spray at full pressure until the faucet valve is completely opened.

The alternative method of allowing the water to run constantly while shaving wastes water and energy in an amount that may be more or less than that wasted by running the water constantly at a faucet unadorned with the device. The spray from the jets during the period that the razor head is not within the device may, however, splash out of the sink basin and damage the clothes of the person shaving or other nearby items. Also, the steam from this constant spray may fog the mirror used by the person shaving, making shaving more difficult.

Second, the cavity into which the razor head must be inserted for cleaning is difficult to use and may damage the razor blades. The cleaning cavity is sized so as to snugly receive an ordinary safety razor head of the cooperating parallel blade type; care and skill must therefore be used each time the razor head is to be inserted into the cavity. The razor blades, the cleaning device, or both may be damaged each time the razor hits the edge of any of the four walls defining the cavity. Damage to the razor blades could result in the razor cutting the person shaving and, of course, in the need to replace the razor blades.

Third, device cannot be used separately from a faucet, as the device contains no valve or control other than that provided by the faucet. This may require removal of the faucet aerator each time the device is attached to the faucet, or may require a specially sized aerator to mate with the device. While the device is attached to the faucet, of course, the faucet cannot be used independently of the device, making it difficult, for example, for one person to use the faucet to brush his or her teeth while another is using the device to shave.

Yet another solution is to tap the razor against the sink. This method is not efficient and may damage the razor.

Some people actually discard otherwise usable razors simply because the cleaning process is so onerous. Obviously, this is not a desirable method of caring for razors.

Therefore, there is a need for a device that efficiently and conveniently cleans razors.

### SUMMARY OF THE INVENTION

The above-discussed disadvantages of the prior art are overcome by a device into which a razor is placed and which includes a chamber through which water is circulated to clean the razor. Water jets are included to direct water against the razor. The device further includes a holder for razors after cleaning.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a razor cleaning device embodying the present invention.

FIG. 2 is a view taken along line 2-2 of FIG. 1.

### DETAILED DESCRIPTION OF THE INVENTION

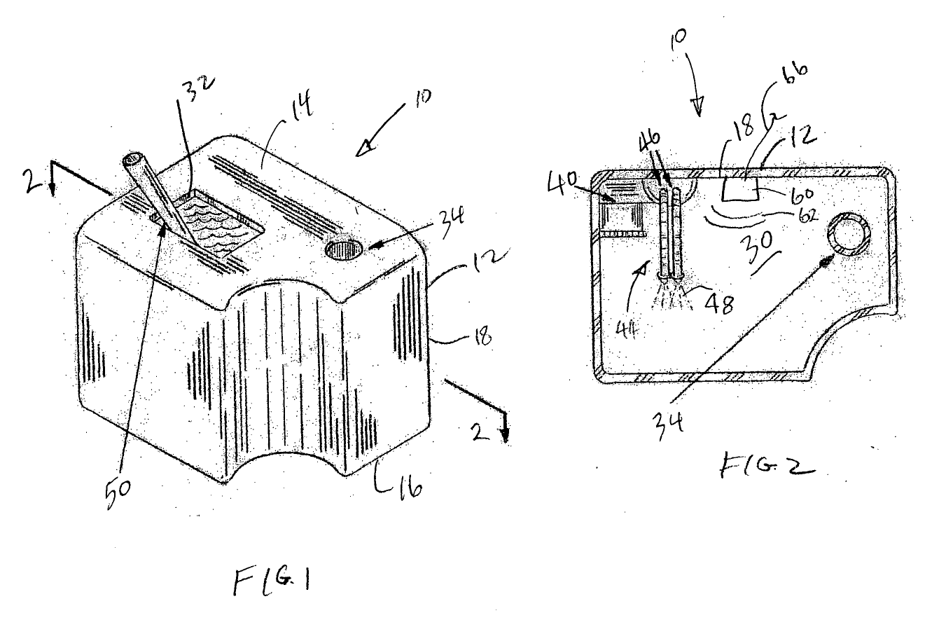

Referring to the figures, it can be understood that the present invention is embodied in a razor cleaning device 10. Device 10 comprises a container housing 12 which includes a first surface 14 which is a top surface when the housing is in use such as shown in FIG. 1, a second surface 16 which is a bottom surface when the housing is in use and a side wall 18 which connects the first and second surfaces together.

An interior volume 30 is defined by the first and second surfaces and the side wall and which will contain fluid, such as water, which will be used to clean a razor. First surface 14 has an opening 32 defined therethrough into the interior volume, and a blind-ended bore 34 is defined in the first surface at a location that is spaced apart from the opening. A razor can be stored in the blind-ended bore between uses.

A water pump 40 is located in the interior volume. Water pump 40 is adapted to be fluidically connected to the interior volume to circulate water located outside the interior volume and is connected to a power source (not shown) and operates in a manner well known to those skilled in the art. It is also noted that any suitable fluid can be used in device 10 and the disclosure of water is not intended to be limiting.

A water dispensing nozzle unit 44 having two nozzles 46 is mounted on the side wall inside the interior volume. Nozzle unit 44 is fluidically connected to the water pump and located to spray water as indicated by spray pattern 48 in FIG. 2 adjacent to opening 32 defined through the first surface so that a razor 50 extending through the opening into the interior volume will be sprayed with water from the nozzle.

A sound generator, such as speaker 60, can be located inside the interior volume to generate sound waves 62 which will impinge on a razor inserted through opening 32 to assist the cleaning of the razor. A power cord 66 will connect the speaker and the pump to a power source.

A razor is inserted through opening 32, the pump is activated and liquid is sprayed onto the razor head that is located inside the interior volume to clean the razor. After cleaning, the cleaned razor is placed, handle first, into bore 34 for storage. It is also noted that two razors can be used, with one razor being stored in bore 34 while the other razor is being cleaned, or one razor can be used while the other razor is being cleaned.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A razor cleaning device comprising:
A) container housing which includes
(1) a first surface which is a top surface when the housing is in use,
(2) a second surface which is a bottom surface when the housing is in use,
(3) a side wall which connects the first and second surfaces together,
(4) an interior volume defined by the first and second surfaces and the side wall,
(5) the first surface having an opening defined therethrough into the interior volume, and
(6) a blind-ended bore defined in the first surface at a location that is spaced apart from the opening;
B) a water pump located in the interior volume, the water pump being adapted to be fluidically connected to the interior volume to circulate water located outside the interior volume; and
C) a water dispensing nozzle fluidically connected to the water pump and located to spray water adjacent to the opening defined through the first surface so that a razor extending through the opening into the interior volume will be sprayed with water from the nozzle.

2. The razor cleaning device defined in claim 1 further including a sound generator located in the interior volume adjacent to the opening defined through the first surface to direct sound waves against a razor extending through the opening into the interior volume.

3. A razor cleaning device comprising:
A) container housing having an interior volume and an opening defined therethrough into the interior volume;
B) a water pump located in the interior volume, the water pump being adapted to be fluidically connected to the interior volume to circulate water located outside the interior volume; and
C) a water dispensing nozzle fluidically connected to the water pump and located to spray water adjacent to the opening defined through the first surface so that a razor extending through the opening into the interior volume will be sprayed with water from the nozzle.
